(19) United States
(12) Patent Application Publication
(10) Pub. No.: US 2026/0205051 A1
(43) Pub. Date: Jul. 16, 2026

(54) SOLAR PANEL MOUNTING SYSTEM

(71) Applicant: RV Mobile Power, LLC, Columbus, OH (US)

(72) Inventor: Jimmy Conroy, Columbus, OH (US)

(73) Assignee: RV Mobile Power, LLC, Columbus, OH (US)

(21) Appl. No.: 19/024,362

(22) Filed: Jan. 16, 2025

(51) Int. Cl. H02S 20/30

(52) U.S. Cl. CPC H02S 20/30

(57) ABSTRACT

Disclosed herein are various embodiments for a mounting system having a lower solar panel mast connected to an upper solar panel mast through a rotating connection, a lower solar assembly extending away from a mid-point of the upper solar panel mast, and an upper solar assembly positioned at a top end of the upper solar panel mast and comprising a base portion attached to the top end of the upper solar panel mast and a rotating portion attached to the base portion. Some embodiments include a plurality of apertures placed around the rotating portion; and a pin sized to pass through an aperture and the base portion.

### BACKGROUND

Solar panels, and specifically those used with mobile applications, must be mounted for both security and also adjustability. Solar panels are exposed to outdoor conditions like strong winds, heavy rain, snow, and other weather-related stress. A secure mounting system ensures that the panels stay in place, preventing them from being damaged or becoming hazardous by falling or getting blown away. Properly securing solar panels protects not only the panels themselves but also the substructure like a frame or a vehicle, ensuring long-term durability and preventing potential damage to the underlying structure. The angle and orientation of solar panels affect how much sunlight they capture, which directly influences their energy output. The sun's position in the sky changes throughout the year, so adjustable mounts allow the panels to be repositioned to maximize exposure and efficiency at different times and seasons. When used on mobile applications, the position of the panels may have to change to accommodate a different geographical location, or storage while in transport, so adjustable mounts allow the panels to be repositioned to maximize exposure and efficiency at different locations.

### SUMMARY

Disclosed herein are various embodiments of a mounting system having a lower solar panel mast connected to an upper solar panel mast through a rotating connection, a lower solar assembly extending away from a mid-point of the upper solar panel mast, an upper solar assembly positioned at a top end of the upper solar panel mast and comprising a base portion attached to the top end of the upper solar panel mast and a rotating portion attached to the base portion. Some mounting systems include where the rotating connection allows the upper solar panel mast to rotate about a vertical centerline of the upper solar panel mast.

Some mounting systems include where the upper solar panel mast and lower solar panel mast share a common vertical centerline. Some mounting systems include a plurality of apertures placed around the rotating portion, and a pin sized to pass through an aperture and the base portion. Some mounting systems include where the lower solar assembly having a shelf providing a flat surface, and a pair of horizontal arms attached to the flat surface. Some mounting systems include where the horizontal arms are cantilevered away from the flat surface. Some mounting systems include a lower solar frame attached to the horizontal arms, and a lower solar panel attached to the lower solar frame.

Some mounting systems include a lower solar frame having a pair of lateral frame elements each one having a top portion and a bottom portion, a first medial frame elements connecting the lateral frame elements at the top portions, and a second medial frame element connecting the lateral frame elements at the bottom portions, wherein the horizonal arms are connected to the lateral frame elements. Some mounting systems include a lower solar panel mast connected to an upper solar panel mast, an upper solar assembly positioned at a top end of the upper solar panel mast, a lower solar assembly attached to the upper solar panel mast and having a shelf, one or more horizontal arms extending away from the shelf, and a lower solar frame attached to the horizontal arms.

Some mounting systems include a base portion attached to the top end of the upper solar panel mast, and a rotating portion attached to the base portion. Some mounting systems include where the horizontal arms are cantilevered away from the shelf. Some mounting systems include where each horizontal arm includes a portion that is placed above the shelf and a cantilevered portion which is cantilevered away from the shelf.

Some mounting systems include where the lower solar frame includes a pair of lateral frame elements each one having a top portion and a bottom portion, a first medial frame elements connecting the lateral frame elements at the top portions, and a second medial frame element connecting the lateral frame elements at the bottom portions. Some mounting systems include where the horizonal arms are connected to the lateral frame elements. Some mounting systems include where a rotating connection placed between the lower solar panel mast and the upper solar panel mast.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

These drawings illustrate certain aspects of some of the embodiments of the present disclosure and should not be used to limit the disclosure.

FIG. 1 is a right-side projection view of one embodiment of a solar panel mounting system used with a mobile security trailer system.

FIG. 2 is a right-side projection view of the solar panel mounting system shown in FIG. 1 where several elements have been removed for clarity, this figure also showing the location of Detail A.

FIG. 3 is a detailed view of Detail A shown in FIG. 2.

FIG. 4 is a rear perspective view of the solar panel mounting system shown in FIG. 2 and showing the location of Detail B.

FIG. 5 is a detailed view of Detail B shown in FIG. 4 and also showing the location of Detail C.

FIG. 6 is a detailed perspective view of Detail C shown in FIG. 5.

FIG. 7 is a perspective view of one embodiment for the rotating portion and the base portion of the top solar mount.

FIG. 8 is a rear projection view of an embodiment of the solar panel mounting system placed atop a lower solar panel mast.

### DETAILED DESCRIPTION

10 mobile security trailer system
15 upper solar assembly
16 lower solar assembly
20 top solar panel
22 bottom solar panel
25 lower solar panel mast
26 upper solar panel mast
28 lower circular element
29 upper circular element
30 security camera assembly
31 satellite antenna
35 telescoping camera boom
40 swivel jack
42 horizontal frame extension
45 hitch
50 boom winch
55 port side storage compartment
56 starboard side storage compartment
60 center channel
65 wheel
100 trailer frame
102 trailer tongue
110 rectangular pan
150 rotating connection
155 pin securing assembly
160 central axis
170 upper solar frame
180 lower solar frame
200 shelf
220 horizontal arm
220a portion of horizontal arm atop shelf
220b cantilevered portion of horizontal arm cantilevered away from shelf
300 rotating portion of top solar mount
310 elongate arm
311 circular base
312 apertures
320 base portion of top solar mount
322 locking pin
325 pin actuator
330 pin
340 rotational axis
400 lateral frame element
420 medial frame element
430 cross beam element
450 right angle bracket

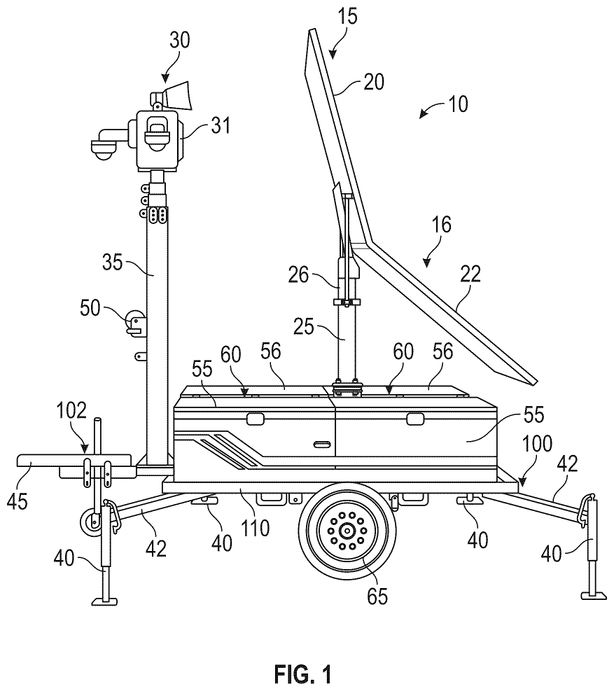

FIG. 1 is a right-side projection view of one embodiment of an exemplary mobile security trailer system 10. This embodiment may include a trailer frame 100 having a rectangular pan 110 with a vertical sidewall 112 extending upwardly from the outer perimeter of the rectangular pan 110. A trailer tongue 102 may extend in the forward direction from the rectangular pan 110 with a hitch 45 positioned at the forward end of the trailer tongue 102. The trailer frame 100 is supported by two or more wheels 65 which may be positioned directly underneath a lower solar panel mast 25 which may extend upwardly from the rectangular pan 110 to support one or more solar panels. In this embodiment, the solar panel mast 25 supports an upper solar assembly 15 (including a top solar panel 20) along with a lower solar assembly 16 (including a bottom solar panel 22). A horizontal frame extension 42 may extend horizontally away from the trailer 100 at each corner with a swivel jack 40 attached to the end of each frame extension 42 such that the swivel jack 40 is attached so that it can rotate approximately 90 degrees and then expand/lengthen in a downward direction until making contact with the ground.

A port side storage compartment 55 may be positioned within the pan 110 and may be a single compartment, or a combination of two or more compartments placed immediately adjacent to one another. In this particular embodiment, two port side storage compartments 55 are used, each having their own enclosure and door for access. Similarly, a starboard side storage compartment 56 may also be positioned within the pan 110 and may also be a single compartment, or a combination of two or more compartments placed immediately adjacent to one another. In this particular embodiment, two starboard side storage compartments 56 are used, each having their own enclosure and door for access. In some embodiments, a center channel 60 is positioned between the port side compartment 55 and the starboard side compartment 56 and may run the entire length of the trailer frame 100 substantially parallel to and above a medial centerline of the trailer frame 100. The lower solar panel mast 25 may be positioned within this center channel 60, between the port side storage 55 and starboard side storage 56. Each compartment 55/56 may contain one or more components for operating and communicating with the mobile security trailer system 10 which may include but is not limited to: a generator, fuel tank for generator, batteries, solar charge controller, and related electronics for operating the same.

A telescoping camera boom 35 may be positioned forward of the rectangular pan 110 and extending upwardly from a base 38 with a portion that is positioned above the tongue 102. A displacement gap 70 may be located between the telescoping camera boom 35 and one or both of the compartments 55 and 56. It has been discovered that this gap 70 can provide a number of benefits including but not limited to allowing a slight bending or flex in the camera boom 35 without forcing it to be too stiff and also helps to prevent damage to the compartments 55 and 56 during dynamic loading of the camera boom.

A boom winch 50 may be placed on the forward side (facing the tongue 102) of the boom 35 and may be used to raise and lower the boom 35. A security camera assembly 30 may be positioned atop the boom 35 and may contain one or more security cameras having any number of features including motion sensing, night vision, thermal vision, and similar. A satellite antenna 31 may be placed on the backside (facing the solar panels 20/22) of the housing for the camera assembly 30 and may be used to communicate, either through the internet or otherwise, data from the system 10 to a remote location.

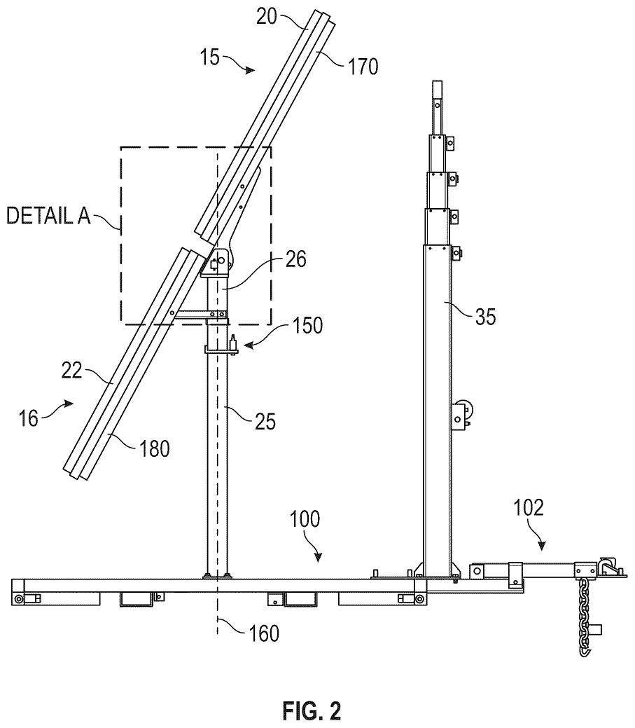

FIG. 2 is a right-side projection view of the solar panel mounting system shown in FIG. 1 where several elements have been removed for clarity, this figure also showing the location of Detail A. A lower solar panel mast 25 may extend upwardly from the trailer frame 100 and connect to an upper solar panel mast 26 through an optional rotating connection 150. A central axis 160 may be positioned vertically and may travel along the centerline of the upper and lower solar panel masts 25 and 26. The upper solar panel mast 26 may then support both the upper solar assembly 15 and lower solar assembly 16 which may include a top solar panel 20 and bottom solar panel 22 respectively. It should be noted that although the upper solar assembly 15 and lower solar assembly 16 have been shown with a single solar panel this is not required as other embodiments may include 2 or more solar panels within each solar assembly 15 or 16.

The upper solar panel assembly 15 may include an upper solar frame 170 which connects with the top solar panel 20 while the lower solar panel assembly 16 may include a lower solar frame 180 which connects with the bottom solar panel 22.

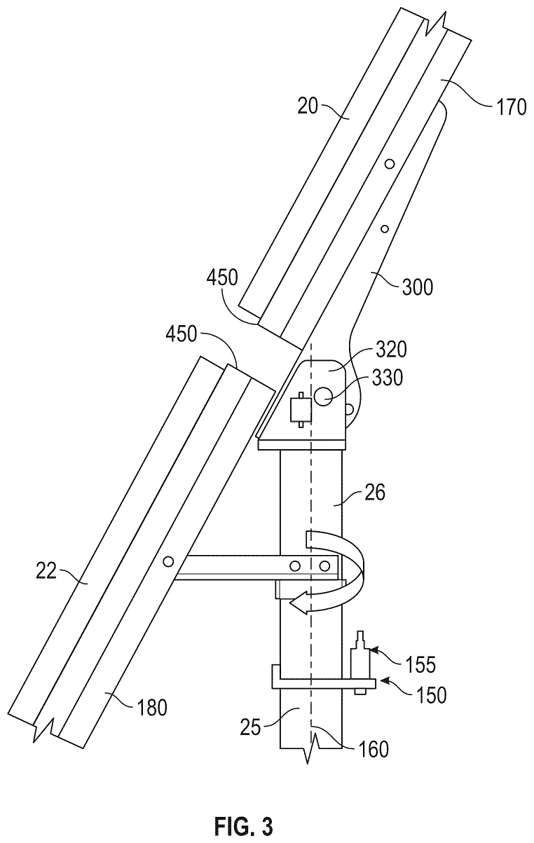

FIG. 3 is a detailed view of Detail A shown in FIG. 2. In this embodiment, the lower solar panel mast 25 may remain stationary while the upper solar panel mast 26 may rotate about their shared central axis 160 through the optional rotating connection 150. A pin securing assembly 155 may be arranged with the rotating connection 150 in order to temporarily fix the rotational position of the upper solar panel mast 26 by using a locking pin or teeth or any equivalent mechanical means. The upper solar frame 170 of the upper solar assembly 15 may be connected to a rotating portion 300 which is hingedly connected to a base portion 320 through the pin 330 which passes through both elements. The base portion 320 may be attached to a top end of the upper solar panel mast 26. The top solar panel 20 may be connected to the upper solar frame 170 with brackets 450 and similarly the bottom solar panel 22 may be connected to the lower solar frame 180 by using brackets 450. Preferably the brackets 450 are right angle brackets but they can also be flat plates which extend from the edge of the frames 170 and 180.

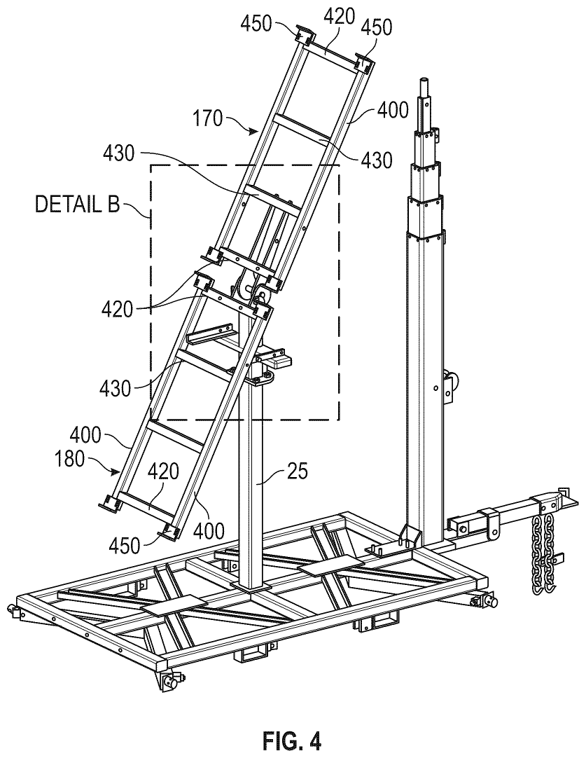

FIG. 4 is a rear perspective view of the solar panel mounting system shown in FIG. 2 and showing the location of Detail B. The upper solar frame 170 may contain a pair of lateral frame elements 400 which may be positioned mostly vertically and have a first and second end. The lateral frame elements 400 may be connected using a first medial frame element 420 placed at a first end of lateral frame element 400 with a second medial frame element 420 placed at a second end of the lateral frame element 400. One or more cross member elements 430 may be used to connect between the lateral frame elements 400 along the span between the first and second ends of the lateral frame elements.

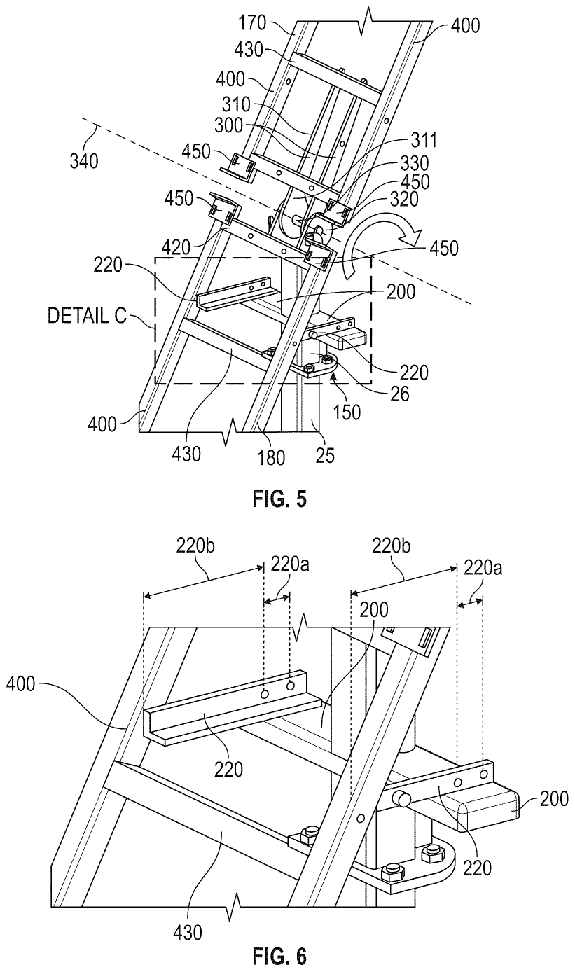

FIG. 5 is a detailed view of Detail B shown in FIG. 4 and also showing the location of Detail C. The rotating portion 300 of the top solar mount may have an elongate arm 310 which extends from a circular base 311 to connect with a cross beam element 430 of the upper frame 170. A pin 330 may pass through both the circular base 311 and the base portion 320 of the top solar mount and provide the rotational axis 340 about which the rotating portion 300 rotates about. The elongate arm 310 may connect to both the cross beam element 430 in addition to the medial frame element 420, or it may connect to only the cross member element 430. With this arrangement, the rotating portion 300 may rotate about the rotational axis 340 to place the upper frame 170 (and top solar panel) in any number of positions, depending on the application.

A shelf 200 may be attached to the upper solar panel mast 26 just above the rotational connection 150 and may be rectangular with an overall length about the same as the medial frame element 420. The shelf 200 may provide a flat surface such that a horizontal arm 220 may connect to the shelf 200 such that the horizontal arm 220 is cantilevered off the top surface and extends away from the upper solar panel mast 26 until connecting to the lateral frame elements 400 which form part of the lower solar frame 180. The horizontal arms 220 may connect to the lateral frame element 400 at a point that is between the medial frame element 420 and the cross beam element 430. Each bracket 450 may be positioned at or near the point where the lateral frame element 420 connects with the medial frame element 420.

FIG. 6 is a detailed perspective view of Detail C shown in FIG. 5. Each horizontal arm 220 may have a portion 220a which is positioned atop the shelf 200 and a cantilevered portion 220b which extends away from the shelf 200 to connect with the lateral frame elements 400.

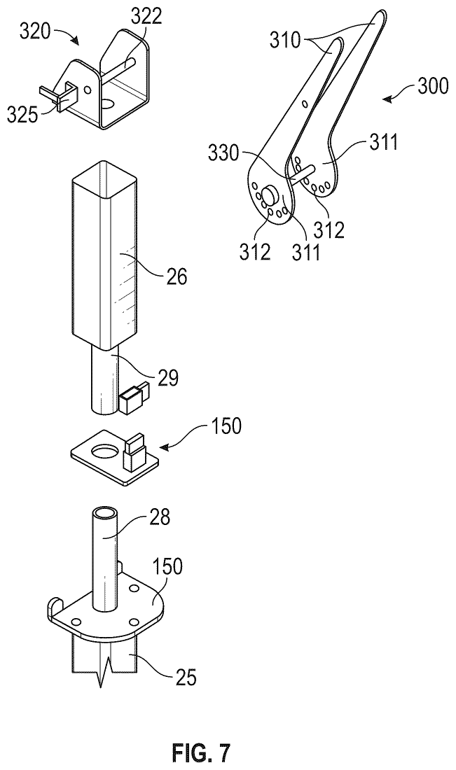

FIG. 7 is perspective view of one embodiment for the rotating portion 300 and the base portion 320 of the top solar mount. In this embodiment, a pair of rotating portions 300 are used with a pin 330 connecting between the two rotating portions 300 at or near the center of the circular bases 311. Each rotating portion 300 may contain a circular base 311 with a series of apertures 312 positioned around the perimeter of the circular base 311 and sized to accept a locking pin 322 to temporarily fix the angular position of the top solar frame 170. The locking pin 330 may be inserted and removed from the apertures 312 by using the pin actuator 325 which may be a ring or handle for the user to grasp in order to slide the locking pin 330 in and out of the apertures 312.

A lower circular element 28 may extend upwardly from the top portion of the lower solar panel mast 25. An upper circular element 29 may extend downwardly from the bottom portion of the upper solar panel mast 26. The lower circular element 28 may have a smaller or larger diameter than the upper circular element 29 so that the two elements can slide atop one another or be accepted into one another. For example, the lower circular element 28 may have a smaller OD than the ID on the upper circular element 29 so that the lower circular element 28 may slide into the upper circular element 29. Conversely, the lower circular element 28 may have a larger ID than the OD on the upper circular element 29 so that the upper circular element 29 may slide into the lower circular element 28. This allows to elements to connect with on another while allowing the rotation with the rotating connection 150 as shown and described herein.

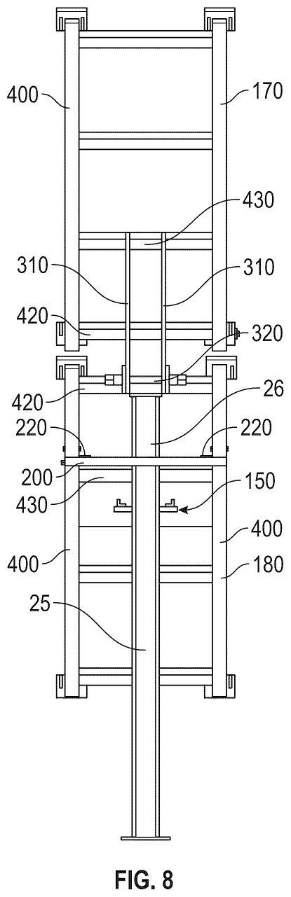

FIG. 8 is a rear projection view of an embodiment of the solar panel mounting system placed atop a lower solar panel mast 25. The elongate arms 310 may be positioned within the central portion of the frames 170 and 180 while the horizontal arms 220 may be positioned outside of the elongate arms 310 and near the outer edge of the frames 170 and 180 near the lateral frame elements 400. The shelf 200 and horizontal arms 220 may be placed between the medial frame element 420 and the first cross beam element 430. The shelf 200 and horizontal arms 220 may be positioned near the first cross beam element 430. The shelf 200 may be parallel to the first cross beam element 430 and the two elements may be almost at the same vertical height with the shelf 200 being just slightly above the first cross beam element 430.

Although the present disclosure and its advantages have been described in detail, it should be understood that various changes, substitutions and alterations may be made herein without departing from the spirit and scope of the disclosure as defined by the appended claims. The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

I claim:

1. A mounting system comprising:
a lower solar panel mast connected to an upper solar panel mast through a rotating connection;
a lower solar assembly extending away from a mid-point of the upper solar panel mast; and
an upper solar assembly positioned at a top end of the upper solar panel mast and comprising
a base portion attached to the top end of the upper solar panel mast, and
a rotating portion attached to the base portion.

2. The mounting system of claim 1 wherein:
the rotating connection allows the upper solar panel mast to rotate about a vertical centerline of the upper solar panel mast.

3. The mounting system of claim 1 wherein:
the upper solar panel mast and lower solar panel mast share a common vertical centerline.

4. The mounting system of claim 1 further comprising:
a plurality of apertures placed around the rotating portion; and
a pin sized to pass through an aperture and the base portion.

5. The mounting system of claim 1 wherein:
the lower solar assembly comprises
a shelf providing a flat surface, and
a pair of horizontal arms attached to the flat surface.

6. The mounting system of claim 5 wherein:
the horizontal arms are cantilevered away from the flat surface.

7. The mounting system of claim 5 further comprising:
a lower solar frame attached to the horizontal arms, and
a lower solar panel attached to the lower solar frame.

8. The mounting system of claim 5 further comprising:
a lower solar frame comprising
a pair of lateral frame elements each one having a top portion and a bottom portion;
a first medial frame elements connecting the lateral frame elements at the top portions; and
a second medial frame element connecting the lateral frame elements at the bottom portions;
wherein the horizonal arms are connected to the lateral frame elements.

9. A mounting system comprising:
a lower solar panel mast connected to an upper solar panel mast;
an upper solar assembly positioned at a top end of the upper solar panel mast;
a lower solar assembly attached to the upper solar panel mast and comprising
a shelf;
one or more horizontal arms extending away from the shelf; and
a lower solar frame attached to the horizontal arms

10. The mounting system of claim 9 further comprising:
a base portion attached to the top end of the upper solar panel mast; and
a rotating portion attached to the base portion.

11. The mounting system of claim 9 wherein:
the horizontal arms are cantilevered away from the shelf.

12. The mounting system of claim 9 wherein:
each horizontal arm comprises
a portion that is placed above the shelf and
a cantilevered portion which is cantilevered away from the shelf.

13. The mounting system of claim 9 wherein
the lower solar frame comprises
a pair of lateral frame elements each one having a top portion and a bottom portion;
a first medial frame elements connecting the lateral frame elements at the top portions; and
a second medial frame element connecting the lateral frame elements at the bottom portions.

14. The mounting system of claim 13 wherein:
the horizonal arms are connected to the lateral frame elements.

15. The mounting system of claim 9 further comprising
a rotating connection placed between the lower solar panel mast and the upper solar panel mast.

16. A mounting system comprising:
a lower solar panel mast connected to an upper solar panel mast through a rotating connection;
a lower solar assembly attached to the upper solar panel mast and comprising
a shelf,
one or more horizontal arms extending away from the shelf, and
a lower solar frame attached to the horizontal arms; and
an upper solar assembly positioned at a top end of the upper solar panel mast and comprising
a base portion attached to the top end of the upper solar panel mast, and
a rotating portion attached to the base portion.

17. The mounting system of claim 16 further comprising:
a plurality of apertures placed around the base portion; and
a pin sized to pass through an aperture and the base portion.

18. The mounting system of claim 16 wherein:
the rotating portion of the upper solar assembly comprises
an elongate arm extending from a circular base, and
a plurality of apertures placed around a perimeter of the circular base.

19. The mounting system of claim 16 wherein:
the horizontal arms are attached to a lower solar frame
the rotating portion is attached to an upper solar frame

20. The mounting system of claim 19 wherein:
the lower solar frame and the upper solar frame each comprises
a pair of lateral frame elements each one having a top portion and a bottom portion;
a first medial frame elements connecting the lateral frame elements at the top portions; and
a second medial frame element connecting the lateral frame elements at the bottom portions.
